(19) United States
(12) Patent Application Publication
(10) Pub. No.: US 2009/0129848 A1
(43) Pub. Date: May 21, 2009

(54) LOTION ROLLER

(76) Inventors: Gil R. TATARSKY, Kingston, NY (US); Neal Patrick BARNES, Medina, MN (US); John C. Adleman, Minneapolis, MN (US)

Correspondence Address: HESLIN ROTHENBERG FARLEY & MESITI PC, 5 COLUMBIA CIRCLE, ALBANY, NY, 12203, US

(21) Appl. No.: 12/265,479

(22) Filed: Nov. 5, 2008

Related U.S. Application Data
(60) Provisional application No. 61/002,410, filed on Nov. 9, 2007.

(51) Int. Cl. A46B 5/02; A47L 25/00; B43M 11/02

(52) U.S. Cl. 401/6; 401/138; 401/220

(57) ABSTRACT

A lotion roller includes a handle assembly and a roller assembly. The handle assembly has a handle with a hollow interior forming a reservoir for receipt of lotion. A threaded shaft passes into the handle reservoir and has a plunger mounted thereon. Rotation of the shaft and movement of the plunger dispenses lotion from the reservoir into a fixed, integral inner perforated tube. The roller assembly has an outer perforated tube that is mounted on and for rotation about the inner perforated tube. A foam roller is glued to the outer perforated tube. The handle of the lotion roller may include a window for viewing the contents of the reservoir. The roller assembly may be stored in a one-piece clam-shell cover that folds over on itself and snaps shut. The lotion roller may have finger grips and a lanyard, have raised ribs, tapered for a better grip and covered with a thin silicone or rubber over-mold.

### CROSS-REFERENCE TO RELATED APPLICATION

The present application is related to Provisional Application Ser. No. 61/002,410 filed Nov. 9, 2007. This prior application is incorporated herein by this reference and the benefit of its filing date is claimed herein as well.

### BACKGROUND OF THE INVENTION

1. Field of the Invention

The present invention relates to an applicator, and, in particular to a lotion roller for applying lotions, medications and other liquids to the human body.

2. Description of the Prior Art

There is nothing more frustrating than trying to self-apply a lotion or other liquid such as a medication to your back and other hard-to-reach places on your body. The process is especially annoying when multiple applications are required and when manual application is utilized, thereby inconveniently covering your hands with the lotion.

In the past, there have been various lotion applicators. Individual products offer certain benefits but none combine all the desirable traits that allow refillable reservoir, smooth and continuous application of a lotion to all parts of the body without streaking, especially to those difficult to reach, and such a product that is travel-friendly.

### SUMMARY

The primary object of the invention is that of an applicator that smoothly and evenly applies lotions and other liquids to the body, even difficult parts of the body, in a smooth, even and simple fashion.

These and other objects, features and advantages are accomplished in accordance with the teachings of the present invention, one illustrative embodiment of which comprises a lotion roller with a handle assembly and a roller assembly. The handle assembly has a handle with a hollow interior forming a reservoir for receipt of lotion. A removable cap is threaded to the proximal end of the handle. There is a turning knob adjacent to the cap. A threaded shaft has one end passing through the cap and is connected to the turning knob. The opposite end of the shaft passes into the handle reservoir and has a plunger mounted thereon. Rotation of the knob causes rotation of the shaft and movement of the plunger to dispense lotion from the handle reservoir through a valve at the distal end of the handle into a fixed, integral inner perforated tube. The roller assembly has an outer perforated tube that is mounted on and for rotation about the inner perforated tube. A foam roller is glued to the outer perforated tube. When snapped into place, there is a small gap or space between the tubes for even dispersion of the lotion.

Proximal and distal contact seals are provided at either end of the roller assembly. The handle of the lotion roller may include a window for viewing the contents of the reservoir. When not in use the roller assembly of the lotion roller may be stored in a one-piece clam-shell roller cover that folds over on itself and snaps shut. The lotion roller may have finger grips and a lanyard, have raised ribs, tapered for a better grip and covered with a thin silicone or rubber over-mold for aesthetic reasons.

### BRIEF DESCRIPTION OF THE DRAWING

Other objects, features and advantages of the present invention will be apparent from the following detailed description and accompany drawing, wherein:

FIG. 1 is an exploded, side view of the handle assembly and roller assembly of the lotion roller of the present invention;

FIG. 2 is an exploded, perspective view of portions of the handle assembly and roller assembly of the lotion roller of the present invention;

FIG. 3 is a perspective view of a completed lotion roller;

FIG. 4 is a perspective view of the lotion roller with clam-shell roller assembly cover;

FIG. 5 is a perspective view of an alternate embodiment of the lotion roller of the present invention, with finger grips and lanyard added to the handle assembly;

FIG. 6 is a perspective view of an alternate embodiment of the present invention with tapered raised ribs for the handle assembly; and,

FIG. 7 is a side view of an alternate embodiment of the lotion roller of the present invention showing a tapered handle, over-mold and feed window.

### DETAILED DESCRIPTION

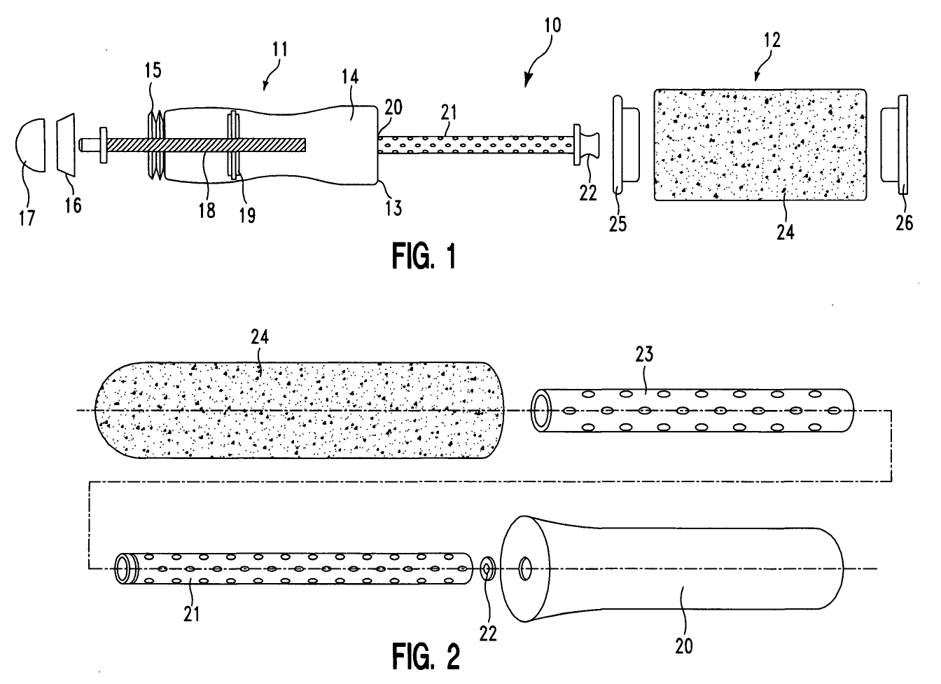

Referring now to FIG. 1 of the drawing, the lotion roller 10 of the present invention is seen as including a handle assembly 11 and a roller assembly 12. The handle assembly 11 comprises a handle 13 having a hollow interior forming a reservoir 14 for receipt of lotion, medication and/or a variety of liquids. The proximal end of the handle is threaded at 15 for receipt of a threaded removable fill cap 16. The fill cap 16 is removed to fill the reservoir 14 with lotion and then threaded back onto the handle 13 to seal off the proximal end of the handle 13. Handle 13 may be extended or elongated, depending upon application.

The assembly 11 further includes a turning knob 17 adjacent to the fill cap 16. A threaded shaft 18 is joined to the knob 17, passing through the fill cap 16 and has a plunger 19 on that portion of the shaft 18 located within the reservoir 14. Upon rotation of the knob 17 and thus the shaft 18, plunger 19 will be moved along the shaft 18 towards the distal end of the handle 13 to dispense lotion from the reservoir 14 towards the roller assembly 12 through a valve 20 at the distal end of the handle 13 and then into a fixed, integral, inner perforated tube 21 with end piece 22.

Referring to FIGS. 1 and 2, the roller assembly 12 is seen as including an outer perforated tube 23 of rigid plastic material and a foam roller 24 mounted about and glued to the outer perforated tube 23. The soft, porous foam allows lotion to travel through and to its outer surface. It is comfortable to a user's skin and resists chemical breakdown from the lotion material.

The outer perforated tube 23 of the roller assembly 12 slides over the inner perforated tube 21 of the handle assembly 11 and snaps onto and rotates about same. The roller assembly 12 snap-fits easily onto and off the inner perforated tube 21 for fast and easy cleaning and replacement. When snapped into place, there is a small gap or space between the tubes 21 and 23. This space allows the lotion to evenly disperse itself.

Proximal and distal contact seals 25, 26 are provided at either end of the roller assembly 12, with the inner tube end piece 22 received within the seal 26. Seals 25, 26 are in contact with inner tube 21 and prevent leakage between the tubes 21, 23. Seals 25,26 have a series of toothed retainers (not shown) arranged rotationally that engage with a mating surface at the distal end of inner tube 21. The toothed retainers flex that allows for a snap-fit.

In use, with the fill cap 16 removed from the proximal end of the handle 13, and the shaft 18 with plunger 19 removed from the reservoir 14, lotion is poured into the reservoir 14. The plunger 19 is re-located all the way up on the threaded shaft 18. The fill cap 16 is then replaced onto the handle 12. Since all of the lotion will be located within reservoir 14 beyond the plunger 19, no lotion seeps into the fill cap-turning knob area. Knob 17, fill cap 16 and shaft 18 form an assembly, from which plunger 19 is removable and moveable.

Then the user turns the knob 17. The desired amount of lotion (or other liquid) is dispensed. The lotion travels from the reservoir, goes through the handle 13 and exits via the holes in inner tube 21. The lotion then enters the outer perforated tube 23 and saturates the foam material of the roller 24. There is a continuous feed of lotion so there is no need to apply and pump. Because the lotion is rolled on there is no streaking and even application (like a paint roller).

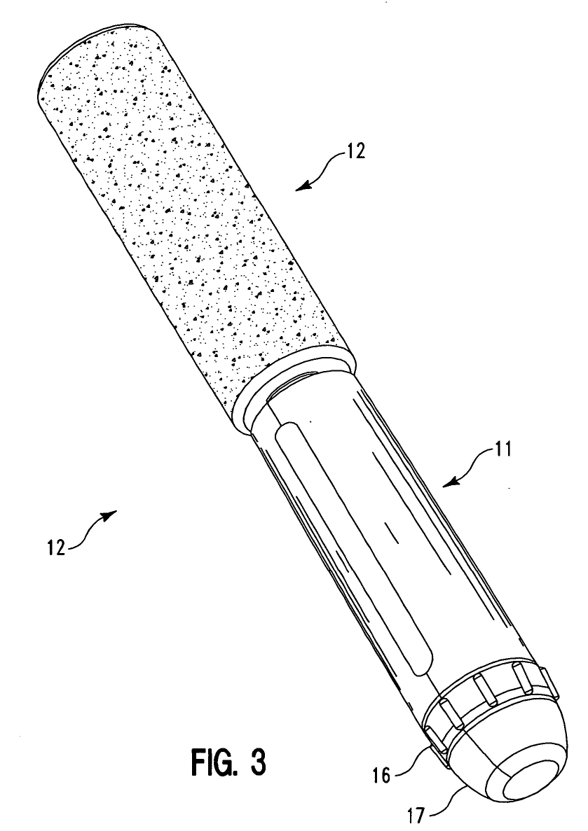

A perspective view of a completed lotion roller 10 is shown in FIG. 3.

The lotion roller 10 can apply lotion over the entire body in less than a minute, including the back and other hard to reach areas. Application is smooth and continuous with no need to pump the device. The lotion doesn't get on your hands, so no messy hands, nails or lotion in the eyes. Application of lotion is applied to just the amount the user intends.

A separate, perforated or slotted tube (not shown) can be added between tubes 21, 23 to take up some of the volume, reducing the lotion needed to fill the gap or space and leads to more even distribution of the lotion.

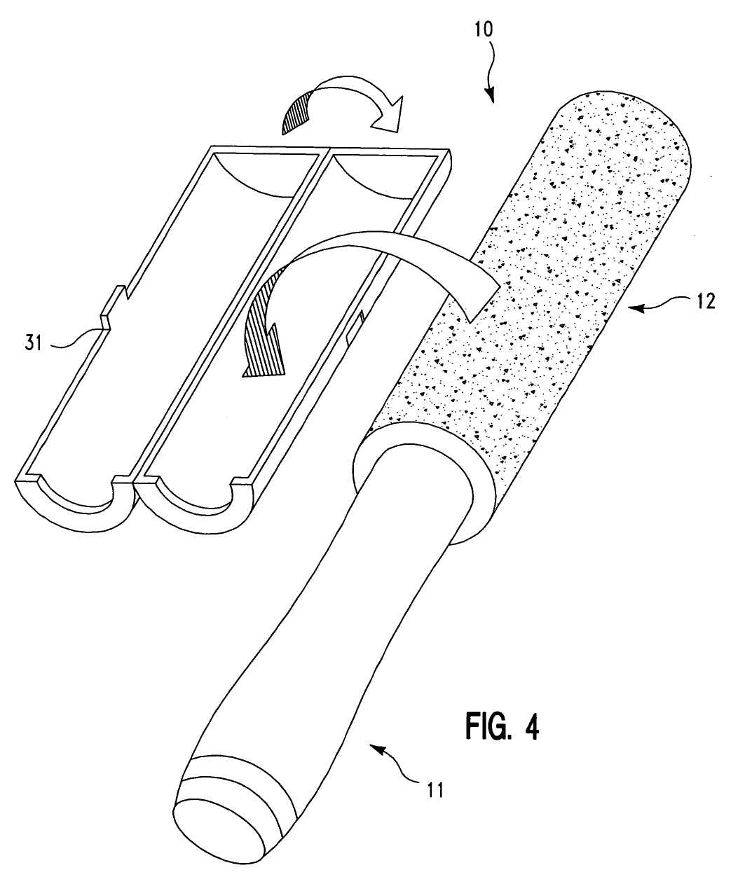

As shown in FIG. 4, when not in use, the roller assembly 12 of the lotion roller 10 may be stored in a one-piece clam-shell roller cover 31 that folds over on itself and snaps shut. The roller assembly 12 is simply dropped into the cover with no mess or clean-up. The cover 31 can stand on end to store the entire lotion roller 10. Also, when the roller assembly 12 is in the cover 3 1, the handle assembly 11 may be pulled on to leave the roller assembly 12 in the cover 31 without getting one's hands on the lotion-filled roller 24. The cover 31 is but one of a variety of cover/holders that could be utilized.

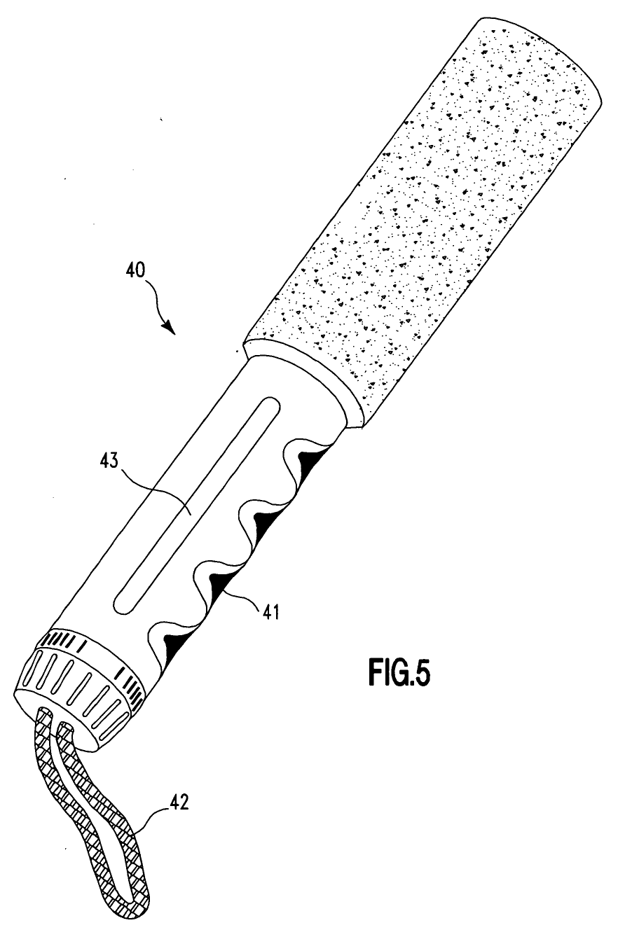

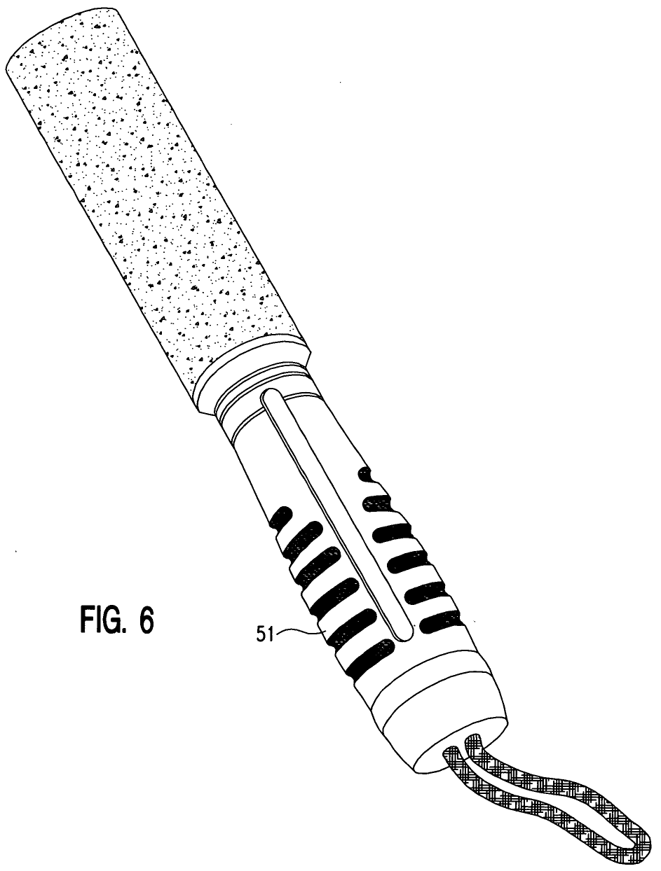

One may add finger grips 41, a lanyard 42 and a feed window 43 to the lotion roller 40, as shown in FIG. 5, or tapered raised ribs 51 as shown in FIG. 6. The ribs 51 help to prevent slippage in the user's hands, especially if there is lotion on the surface.

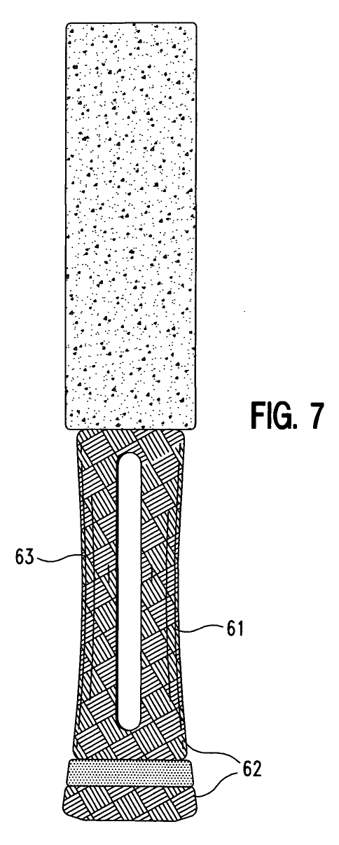

The handle 61 may be tapered for a better grip and may be covered with a thin silicone or rubber over-mold for aesthetic reasons as shown in FIG. 7 at 62, and for gripping ease. The material 62 also increases slip resistance, gives a comfortable, soft surface to the grip, and adds comfort against temperature extremes, as, for example when the lotion roller has been sitting in the sun. Additionally, a feed window 63 can be placed in the handle 61 to keep track of the amount of lotion remaining. It should be obvious that changes, additions and omissions may be made in the details and arrangement of parts without departing from the spirit and scope of the invention as hereinafter claimed.

What is claimed is:

1. A lotion roller comprising a handle assembly with a reservoir for receipt of lotion, a roller assembly rotatable about the handle assembly with an outer foam roller, and means for dispensing lotion from the handle assembly reservoir to the foam roller upon rotation of the roller assembly relative to the handle assembly.

2. A lotion roller comprising:
a handle assembly having
a handle with a reservoir for receipt of lotion,
an axial, inner perforated tube integral with the handle, and,
means for dispensing lotion from the reservoir to and through the axial inner perforated tube; and,
a roller assembly for rotation about the handle assembly having
at least one outer perforated tube for rotation about the handle assembly inner perforated tube and in liquid communication with same, and,
a foam roller mounted on the outer perforated tube for applying lotion to a user from the handle assembly reservoir through the inner and outer perforated tubes.

3. The lotion roller of claim 2 including a window in the handle assembly for viewing the contents of the reservoir.

4. A lotion roller, comprising:
a handle assembly having
a handle with a hollow interior forming a reservoir for receipt of lotion and including
a threaded proximal end and
a distal end,
a removable fill cap for threading to and sealing off the handle proximal end and with
a turning knob,
a threaded shaft connected to the turning knob through the fill cap with a plunger mounted on the shaft for dispensing lotion from the reservoir upon rotation of the turning knob,
a valve at the distal end of the handle, and,
an inner perforated tube integral with the handle in alignment with the valve and having
an end piece; and,
a roller assembly having
at least one outer perforated tube mounted on and for rotation about the handle assembly inner perforated tube,
a foam roller adhered to the outer perforated tube, and,
proximal and distal seals at either end of the roller assembly, the distal end cap receiving the inner perforated tube end piece.

5. The lotion roller of claim 4 including a window in the handle for viewing the contents of the reservoir.

6. The lotion roller of claim 4 including a clam-shell cover for folding over and snapping shut on the roller assembly.

7. The lotion roller of claim 4 including finger grips on the handle.

8. The lotion roller of claim 4 including a lanyard depending from the handle.

9. The lotion roller of claim 4 wherein the handle is tapered.

10. The lotion roller of claim 4 wherein the handle has raised ribs.

11. The lotion roller of claim 4 wherein the handle is covered with an over-mold.
